(19) United States
(12) Patent Application Publication
(10) Pub. No.: US 2022/0405859 A1
(43) Pub. Date: Dec. 22, 2022

(54) RECOMMENDATION SYSTEM FOR RECORDING A TRANSACTION

(71) Applicant: INTUIT INC., Mountain View, CA (US)

(72) Inventors: Yair HORESH, Kfar-Saba (IL); Sheer DANGOOR, Ramat-Gan (IL)

(21) Appl. No.: 17/349,609

(22) Filed: Jun. 16, 2021

(51) Int. Cl. G06Q 40/00; G06Q 40/02; G06Q 30/02; G06N 7/00

(52) U.S. Cl. CPC G06Q 40/12; G06Q 40/02; G06Q 30/0201; G06N 7/005; G06Q 40/10

(57) ABSTRACT

Certain aspects of the present disclosure provide techniques for providing an indicator to an inexperience business owner to enter transactions into an accounting system. Transaction data from applications is grouped into two groups based on experience of each group. Transaction data from an experienced group will have transactions with accounting professionals, while an inexperienced group may not, or have fewer such transactions. A transaction is decomposed into at least two transaction events, each with showing two accounts per transaction event, as per double entry accounting rules. Probability values for each transaction event are determined based on the accounts involved: probability value=p(account_1=account_type_1, credit/debit amount, account_2=account_type_2, credit/debit amount|previous event account_3=account_type_3, credit/debit amount, account_4=account_type_4, credit/debit amount). Probability values overexpressed for the experienced group relative to the inexperienced group indicate using different accounts may be more optimal to the inexperienced group.

### INTRODUCTION

Aspects of the present disclosure relate to transaction event classification, and more particularly to transaction event probability value based on account information.

Accounting is a complex science; in conventional double entry accounting systems, a transaction may be assigned to two of five high level account types: assets, equity, liabilities, income, and expense. Each of these high level account types have sub-accounts. There may be many legal ways to record transactions in double entry accounting systems, with some being more or less accurate methods of recording than others. Moreover, how a transaction is recorded, that is, in which accounts or sub-accounts are components of the transaction recorded may have tax and other implications. For example, refunds can be recorded as income, but from an accounting perspective it may be more accurate (and advantageous) to record them as a negative expense. Another example, how meals are recorded as regular meals vs a business meal (i.e., recorded as an expense) may have tax implications—the business meal may be tax deductible, while the regular meal is not.

While experienced business owners hire accounting experts (e.g., accountants and book keepers) who have a deep understanding of properly recording transactions, inexperienced business owners who work on their own do not. As a result, inexperienced business owners may record transactions that, while legal/proper, do not account for a given transaction so as to provide the inexperienced business owner with an optimal outcome, such as for purposes of taxes.

Accordingly, what is needed are systems and methods for developing recommendations for recording transactions.

### BRIEF SUMMARY

Certain embodiments provide a method that includes receiving a plurality of transaction events, each transaction event comprising an entity attribute identifying an associated entity of a first type or a second type, a first account type, a second account type, and a transaction type, grouping the plurality of transaction events based on the entity attribute to a first entity group and second entity group, and generating a first probability value for the first entity group and a second probability value for the second entity group, each of the first and second probability value comprising a probability value of the first account type given the second account type. The method further includes identifying that the first probability value is greater than the second probability value for transaction events grouped together based on transaction type, and providing recommendation to an application associated with an entity of the second entity type, to modify one of the first account type and the second account type of a subsequent transaction event.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

Certain embodiments provide a system for recommending an account for recordation of a transaction, that includes a memory comprising computer-readable instructions, a processor configured to execute the computer-readable instructions, that cause the system to receive a plurality of transactions, each comprising one or more journal entries, group the plurality of transactions into one of an experienced group or an inexperienced group, and extract the one or more journal entries for each transaction, each journal entry comprising at least two accounts of a chart of accounts, and at least two journal entries being associated with each transaction of the plurality of transactions. The processor is further configured to cause the system to calculate, for each transaction, a probability value for a journal entry based on the at least two accounts, identify an overexpressed probability value associated with transactions from the experienced group relative to the inexperienced group, generate a recommendation for the inexperienced group based on the overexpressed probability value, and transmit the recommendation to the inexperienced group.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts a block diagram for a recommendation system, according to certain embodiments.

FIG. 2 depicts a method for a recommendation system, according to certain embodiments.

FIG. 3 depicts a method for a recommendation system, according to certain embodiments.

FIG. 4 depicts an example server for a recommendation system that may perform the methods described herein, according to certain embodiments.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Aspects of the present disclosure provide apparatuses, methods, processing systems, and computer-readable mediums for a recommendation system for recording a transaction. Certain aspects of the present disclosure provide techniques for providing a recommendation to an inexperienced business owner to optimally enter transactions into an accounting system. Transaction data from applications is grouped into two groups based on experience of each group. Transaction data from an experienced group will have transactions with accounting professionals, while an inexperienced group may not, or have fewer such transactions. A transaction is decomposed into at least two transaction events, each with two accounts per transaction event, as per double entry accounting rules. Probability values for each transaction event are determined based on the accounts involved. For example: probability value=p(account_1=account_type_1, credit/debit amount, account_2=account_type_2, credit/debit amount previous event account_3=account_type_3, credit/debit amount, account_4=account_type_4, credit/debit amount). Probability values overexpressed for the experienced group relative to the inexperienced group indicate using different accounts may be more optimal to the inexperienced group. In this context, a probability value that is overexpressed for the experienced group relative to the same probability value for the inexperienced group is a probability value that is greater than the same probability value for the inexperienced group, and according to certain embodiments, the amount by which the probability value is greater is statistically significant or above a user defined threshold.

In double entry accounting, each side of a transaction is entered as a credit to one account (or sub account) and a debit in another, and choices of accounts to accrue these values to can impact financial aspects of a business. For example, choice of accounts for accounting purposes can affect how the business accrues expenses, income, revenue, and other financial aspects, that may ultimately affect how the business is taxed. An experienced business owner will frequently hire a professional (e.g., accountant or book keeper) who will be informed on accurate accounting entry to maximize value to the business; an inexperience owner will do this themselves, for example, accruing to accounts that look to be correct based on their names. For example, while an inexperienced business owner may account for a refund as income and increase taxable income unnecessarily. On the other hand, an experienced business owner, with help of their accountant, would more accurately log the refund as a negative expense that impacts the expense account and does not increase taxable income. Similarly for meals—while the inexperienced business owner would account for all meals as “meals,” the experienced business owner would differentiate between regular meals and business meals, the latter being tax deductible.

To assist the inexperienced business owner, certain embodiments disclose methods and system to recommend optimal account designations. Transaction data that includes accounts for accrual, is obtained and divided into two groups—one group of transaction data from experienced business owners, and the other group from inexperienced business owners. Experienced vs inexperienced business owners in this context are determined based on transaction data with financial service professionals. The experienced group is identified based on having one or more transactions with financial service professionals, showing that they work with accountants or other advisors. The inexperienced group's data will lack transactions with financial professional, indicating they're doing their accounting entries with little or no professional help.

For each group's data, accounting journal entries are extracted and grouped by transaction counterpart, and sorted by date. In this context a journal entry is the entry of a transaction into a chart of accounts. In double entry accounting, each entry will involve two accounts, an account that is credited and an account that is debited. Each transaction includes a transaction date, a counterpart, an amount and two accounts (as required by double entry accounting). For example, two events could be: an issued invoice (a first event) that was paid after a few days (the second event): counterpart John Harris; date 4 Jan. 2021; amount $250; account_1: accounts receivable (debit), account_2: income (credit). Event two could include: data 13 Jan. 2021; amount $250; account_1: accounts receivable (credit), account_2: checking (debit). According to certain embodiments, an external repository, such as DUNN & BRADSTRADSTREET™, may be used to obtain attributes of each party to the transaction.

In some embodiments, the parties and counterparties of each transaction are replaced with a vector of business information and transaction context attributes, which may include industry, size, and business type of each party, as well as payment type (e.g., check, wire transfer, credit card, cash, etc.), amount, product vs services based transaction, and other attributes of the transaction.

Transactions (e.g., invoices on the payee side, purchase orders on the payer side) are grouped based on transaction amount size (e.g., $0-10, $11-100, $101-1000, etc.), and account names are normalized using stemming and a short list of synonyms generated based on common groupings (e.g., checking, checking account, checking acc, etc., would be grouped together).

Probability values are then generated for accounting events, and conditional probability values based on the second (and additional) accounts used. For example, a probability value format may consist of p(account_1=XXX, credit/debit, account_2=XXX credit/debit prey. event was account_3=XXX, credit/debit, account_4=XXX) (where the “|” symbol indicates “given that”), for similar transaction contexts. A transaction context may be based on an attribute of a business (industry, business age, monthly revenue, number of employees, and the like) and/or an attribute of the transaction (e.g., transaction amount size). A similar transaction context may be parties to a transaction who are in the same industry, have the same or similar monthly revenues (e.g., within 10% of each other), and/or transaction amount size that are in the same group (e.g., $0-10, $11-100, $101-1000, etc.).

Once probability values are generated for each transaction in each group, probability values that are over expressed in the experienced group relative to the inexperienced group are determined. Over expressed probability values are recorded as representative of account groupings utilized by the experienced group for recording transactions, which the inexperienced group is not using in statistically relevant numbers. Recommendations to inexperienced group members are then generated based on the accounting groupings from the overexpressed probability value account groupings.

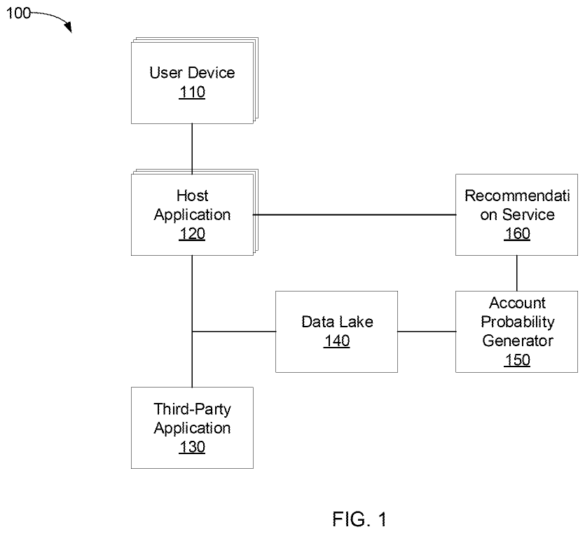

FIG. 1 depicts a block diagram 100 for a recommendation system, according to certain embodiments. A user device 110, such as a mobile or desktop computing device suitable for receiving transaction data from a user (not shown) is coupled to a host application 120. Host application 120 in this context according to certain embodiments is configured to receive data related to a financial transaction from one or more user devices 110. Host application 120 may be configured for financial management, small business management, tax preparation, or any host application configured to receive and process transactional data. In certain embodiments, host application 120 may be QUICKBOOKS™ or QUICKBOOKS ONLINE™ from Intuit Inc. of Mountain View, Calif. Host application 120 receives transaction data from a user device and all host applications 120 provide transactional data to a data lake 140.

Transaction data in this context includes data for one or more transaction events, and according to certain embodiments may include a transaction amount, parties to the transaction including a party and a counter party, and one or more accounts involved in recording the transaction. A transaction can include two events for each party to the transaction. For example, for a payee, a first event may include the issuance of an invoice indicating products or services rendered to a payer, while a second event may include actual receipt of payment from the payer. In the same example, for a payer, receipt of the invoice may be a first transaction event and issuance of payment to the payee being the second event. Each event from each party includes data entry into at least two accounts, based on double entry accounting principles. Accordingly, each transaction provided by the host application 120 to the data lake 140 comprises at least two transaction events from each party to the transaction—two events from a host application 120 of a payee and two from the host application 120 of a payer.

According to certain embodiments, host application 120 may additionally provide a context for each transaction that includes size of each party to the transaction (which can be measured by various metrics, such as number of employees or annual revenue), industry of each party to the transaction, payment type (e.g., check, cash, credit card, etc.), and business type. Further information of the parties may be obtained from a third party application 130 that according to certain embodiments may be an information service such as DUNN & BRADSTREET™.

Account probability value generator 150 is coupled to data lake 140, receiving transaction event information and context related to each transaction event. Account probability value generator 150 divides transaction events into two groups, experienced and inexperienced. For business entities having transactions with financial professionals such as accountants, book keepers, financial analysts, and the like, transaction events are classified as being part of the ‘experienced’ group. Transaction events classified as being in the experienced group are likely to have had oversight from a financial professional when assigning related accounts to each transaction event. Transaction events coming from host applications of business entities having no, or fewer than four, transactions with financial professionals in a one year period, are placed in the ‘inexperienced’ group, indicating little to no oversight of account choice for transaction events by financial professionals.

For each transaction event received from the data lake, journal entry records are received for each party/counterparty (e.g., payer, payee) to the transaction and sorted by date. Sorting by date provides order to the transaction based on the date of each transaction, and transaction event that makes up a transaction. Each transaction event, according to certain embodiments, includes a transaction event date, party owning the transaction (e.g., business entity of the respective host application 120) and counter party to the transaction, amount, and at least two accounts (e.g., as required by double entry accounting).

The account probability value generator 150 matches the party and counterparty to each transaction event against data from the third party application 130, and discards transaction events for which one or both parties cannot be matched.

The account probability value generator 150 then generates a vector of attributes for each party to each transaction event that includes, by way of example, industry of the party, payment type (e.g., credit card, cash, check, wire, block chain, etc.), transaction amount, product/services nature of the transaction event, and the like. By storing business and transaction attributes as a vector, these values may be used to inform context for a given transaction based upon at least one of the vector values. For each counterparty, account probability value generator 150 includes industry, size, and counter party type (e.g., customer, vendor, etc.) in the vector.

Transaction events are further classified into groups based on transaction amount size (e.g., $0-$10, $11-$100, $101-$1000, etc.), party annual transactional volume (e.g., below $100 k, $100 k-$1 M, etc.), and account names are normalized. According to certain embodiments, account names may be normalized using word stemming based on synonyms used for account type names (e.g., checking, checking account, checking acc., would be grouped together in this context). Normalizing account names enables identifying same/similar accounts when names are provided by users of the host application with variations.

Account probability value generator 150 calculates probability values for account combinations for each transaction event, being a probability value of a first account given a second account, for transaction events having similar contexts. According to certain embodiments, a probability value may be generated according to

p(account_1=xxxx, credit/debit, account_2=xxxx, credit/debit|prev. event was account_1=xxxx, credit/debit, account_2=xxxx, credit/debit).

For example, a business entity may perform services (e.g., repairing a roof) for a customer. The transaction will comprise at least two transaction events: an initial transaction event in which the business entity issues an invoice, and a second transaction event in which the business entity receives payment. Example transaction events may appear as follows. An example of data for the first transaction event may be: product/service type: roof repair; transaction event: issuance of an invoice; P(account_1=‘asset’/debit and account_2=‘income’/credit). In the context of: merchant industry=‘retail’, merchant volume=‘below 100K’, counterpart_type=‘customer’, is_recurring_customer=‘No’, payment_method=‘check’, amount=‘50-100$’, transaction_description=‘roof fix’).

An example of data for the second transaction event can be: getting a check (conditional probability value since it is the second step in the chain): (the pipe sign “|” is “given”) P(account_1=“‘asset−account receivables”/debit and account_2=“asset”/credit|account_1=“asset”/debit and account_2=“income”/credit). In the context of: merchant industry=“retail”, merchant volume=“below 100K”, counterpart type=“customer”, is_recurring_customer=“No”, payment_method=“check”, amount=“50-100$”, transaction_description=“roof fix”)

From the above example transaction there are two probability values: a regular probability value for the first transaction event of invoice issuance that includes a debit to an asset account (e.g., labor and materials) and a credit to an income account (e.g., accounts receivable), and a conditional probability value. The second transaction event of receipt of a check for payment includes a conditional probability value: probability value of a debit to accounts receivable and credit to the asset account given the first transaction event elements.

Once probability values are generated for each transaction event, the results are provided to a recommendation service 160. For the experienced group, recommendation service 160 determines probability values that are overexpressed relative to the inexperienced group for transactions having similar contexts. For example, a probability value may be overexpressed if the probability value for the experienced group is at a 0.95 threshold greater than the probability value for the inexperienced group. In some embodiments, this threshold may be as low as 0.85. For transactions having overexpressed values, the charts of accounts are compared as between the experienced and inexperienced groups, and the recommendation service 160 generates a recommendation of chart of account settings host applications being used by inexperienced users. The recommendation service 160 will additionally notify inexperienced users of more optimal ways to record transactions, based on the overexpressed probability value transactions and transaction events of the experienced users, for similar contexts.

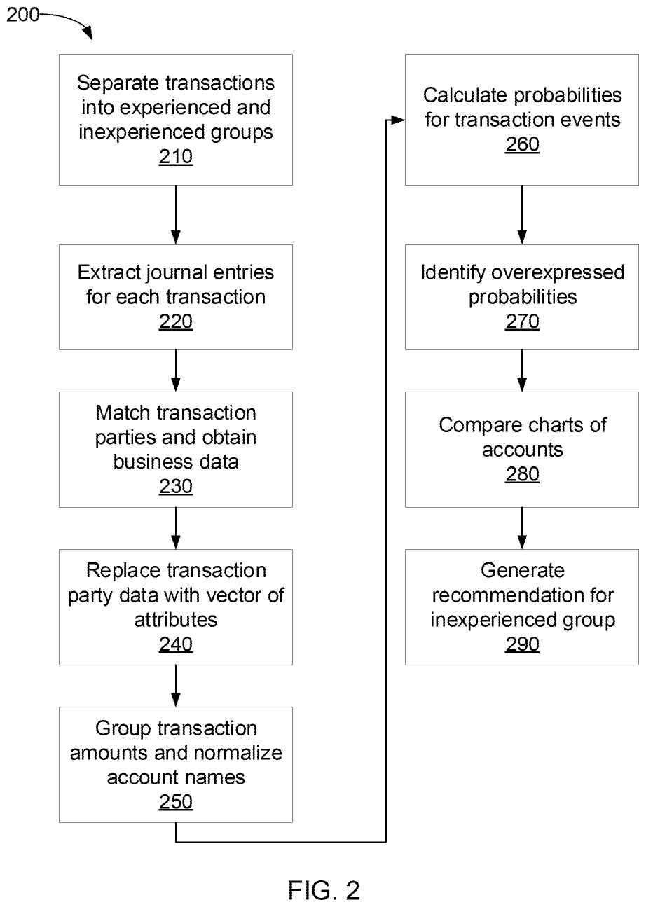

FIG. 2 depicts a method 200 for operating a recommendation system, such as recommendation system 100 of FIG. 1, according to certain embodiments.

At 210, the method 200 receives transactions at data lake 140, such as from one or more host applications 120 of FIG. 1, and separates the transactions into two groups. Transaction data in this context may include amount, payment type, transaction type such (e.g., product, service, meal, entertainment, contribution, donation, etc.), accounts used in recording the transaction, dates of transaction events making up the transaction, party/counterparty, and the like.

In addition to transaction data, the recommendation system receives data regarding the size, revenue, chart of accounts settings (including sub-accounts), and other attributes of each business for which transactions are received. According to certain embodiments, the two groups are defined by experience of the business related to each host application, as indicated by the existence of transactions with financial professionals for a given business. A business having transactions with financial professionals (e.g., fees paid to an accountant or are accountants themselves) is indicated in the ‘experienced’ group, while a business without transactions with financial professionals is indicated as being part of the ‘inexperienced’ group. Experienced group members are more likely to have transactions, and more particularly transaction events related to a given transaction, accrued to accounts that optimize the finances of the business. Optimization in this context may include for tax, for valuation, for funding, or other purpose for which a business may choose to record elements of a transaction. The inexperienced group members are more likely to record a transaction based solely on the name of a given account in the chart of accounts, with little recognition of the financial significance of the choice of account.

At 220, the method extracts journal entries for each transaction. A transaction in this context is comprised of two or more transaction events—a first transaction event may be related to performance of a service/sale of a product and an issuance of an invoice for payment, while a second transaction event may be related to receipt of payment. For each transaction event, as required by double entry accounting, two accounts are used to record the transaction event; one account is credited, while the other is debited. For example, two events used to record a case of an issued invoice (first transaction event) that was paid after a few days (second transaction event): counterpart: John Harris; date 4 Jan. 21 (first event), amount: $250, account_1: accounts receivables (debit), account_2: income (credit); date: 13 Jan. 21 (second event), amount: $250, account_1: accounts receivables (credit), account_2: checking (debit).

At 230, the parties to the transaction are matched in a third-party database, such as third-party application 130.

At 240, the transaction data and business attribute data of each party to the received transactions is replaced with a vector of attributes.

At 250, the method groups transactions by transaction amounts, in groups of exponential size: $0-$10, $11-$100, $101-$1000, etc. Further, account names for accounts used in recording transaction events are normalized using stemming and a short list of synonyms (e.g., checking, checking account, checking acc, and the like, will be grouped together under the same name).

At 260, probability values for transaction events are generated by the method 200. As discussed above, a transaction may be decomposed into two transaction events. A first transaction event, for example from the point of view of a seller may be the provision of a product/service in connection with issuance of a request for payment such as an invoice, while a second transaction event in this same example would be receipt of such payment. Conversely, from the buyer perspective, the first transaction event may be the receipt of a product/service and the related request for compensation from the seller, while the second event would be the issuance of remuneration to the seller. In this context, a probability value is generated for the first transaction event, that is p(account_1=name account1, credit/debit, account_2=name_account2, debit/credit), and a conditional probability value is generated for the second transaction event, namely conditional p(account_3=name_account3, credit/debit, account_4=name_account4 debit/credit p(account_1=name account1, credit/debit, account_2=name_account2, debit/credit)).

At 270, probability values are identified for transaction event account combinations that are overexpressed in the experienced group relative to the inexperienced group for similar transaction types, and records these probability values.

At 280, compares charts of accounts settings are compared, looking for instances where the experienced group has accounts/sub-accounts that are overexpressed for the experienced group relative to the inexperienced group.

At 290, recommendations are generated for members of the inexperienced group that indicates accounts/sub-accounts that the member may not have, and transaction event account combinations that are overexpressed in the experienced group relative to the inexperienced group for similar transactions types.

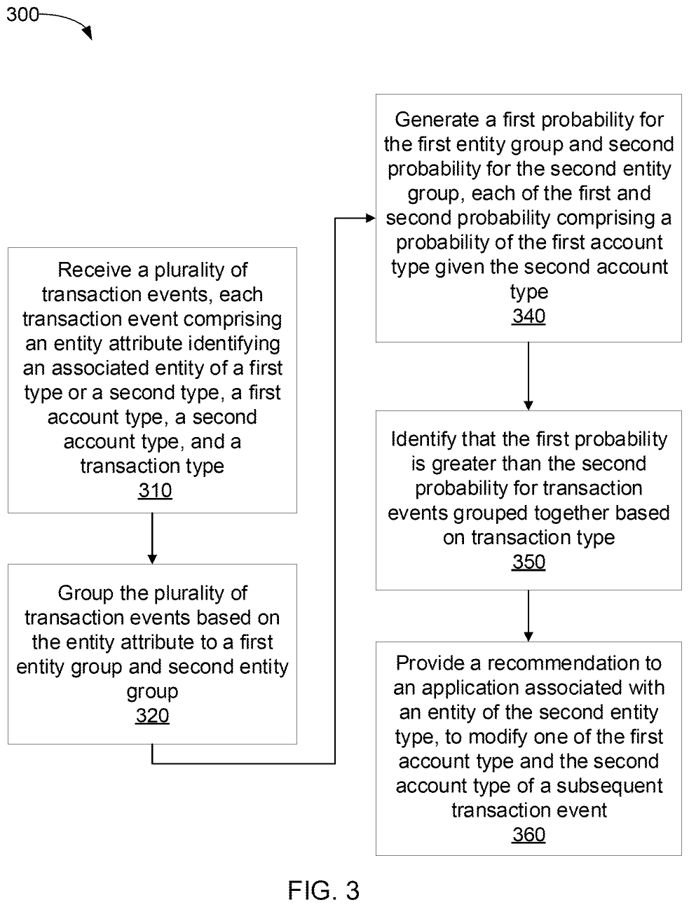

FIG. 3 depicts a method 300 for a recommendation system, according to certain embodiments.

At 310, a plurality of transaction events are received, each transaction event comprising an entity attribute identifying an associated entity of a first type or a second type, a first account type, a second account type, and a transaction type. According to certain embodiments, the receiving may further comprise receiving the plurality of transaction events further comprises receiving a third account and a fourth account for each of the plurality of transaction events. In certain embodiments, the first entity type is experienced and the second entity type is inexperienced.

At 320, the plurality of transaction events are grouped based on the entity attribute to a first entity group and second entity group.

At 340 a first probability value is generated for the first entity group and second probability value for the second entity group, each of the first probability value and second probability value comprising a probability value of the first account type given the second account type. According to certain embodiments, generating for each transaction group, a probability value, comprises generating the probability value of the first account type and third account type given the second account type and fourth account type.

At 350, the first probability value is identified as being greater than the second probability value for transaction events grouped together based on transaction type. According to certain embodiments, identifying comprises determining that the first probability value is overexpressed relative to the second probability value, wherein each of the plurality of transaction events further comprises a transaction context comprising at least one of an identifier, an industry identifier, a size, or a business type, of a first party or a second party to each of the plurality of transaction events, a transaction date, and a transaction amount. According to certain embodiments, the method 300 may further comprise generating a vector from the transaction context.

At 360, a recommendation is provided to an application associated with an entity of the second entity type, to modify one of the first account type and the second account type of a subsequent transaction event.

According to certain embodiments, the method 300 may further comprise the plurality of transaction events being received from a plurality of applications, wherein the first entity type or second entity type are associated with each of the plurality of transaction events responsive to the presence of financial services transactions received from each of the plurality of applications.

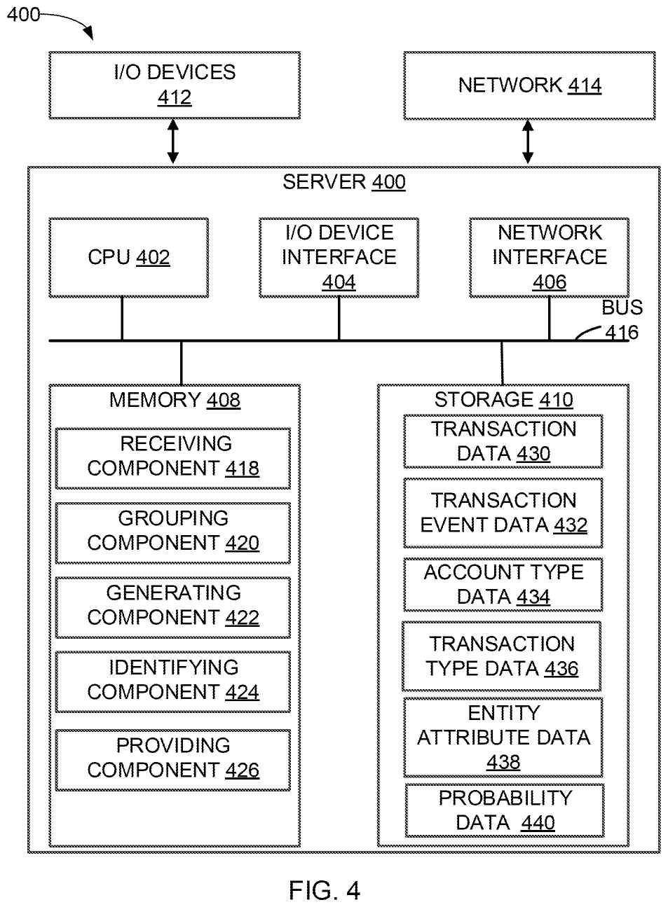

FIG. 4 depicts an example server 400 for a recommendation system that may perform the methods described herein, such as the methods for generating a recommendation for recording a transaction as described in connection with FIGS. 2-3.

Server 400 includes a central processing unit (CPU) 402 connected to a data bus 416. CPU 402 is configured to process computer-executable instructions, e.g., stored in memory 408 or storage 410, and to cause the server 400 to perform methods described herein, for example with respect to FIGS. 2-3. CPU 402 is included to be representative of a single CPU, multiple CPUs, a single CPU having multiple processing cores, and other forms of processing architecture capable of executing computer-executable instructions.

Server 400 further includes input/output (I/O) device(s) 412 and interfaces 404, which allows server 400 to interface with input/output devices 412, such as, for example, keyboards, displays, mouse devices, pen input, and other devices that allow for interaction with server 400. Note that server 400 may connect with external I/O devices through physical and wireless connections (e.g., an external display device). In this context, server 400 may be a distributed computing system such as a cloud computing system that includes computer resources such as CPU's, memory, storage, bus, network interfaces, and the like, or portions thereof, from a number of discrete computers that are orchestrated to operate as a single computer system. Moreover, one or more functions of server 400 may be operate on a user device such as user device 110 of FIG. 1.

Server 400 further includes a network interface 406, which provides server 400 with access to external network 414 and thereby external computing devices.

Server 400 further includes memory 408, which in this example includes a receiving component 418, a grouping component 420, a generating component 422, an identifying component 424, and a providing component 426 for performing operations described in FIGS. 2-3.

Note that while shown as a single memory 408 in FIG. 4 for simplicity, the various aspects stored in memory 408 may be stored in different physical memories, including memories remote from server 400, but all accessible by CPU 402 via internal data connections such as bus 416.

Storage 410 further includes transaction data 430, transaction event data 432, account type data 434, transaction type data 436, entity attribute data 438, and probability value data 440, as described in connection with FIGS. 2-3.

While not depicted in FIG. 4, other aspects may be included in storage 410.

As with memory 408, a single storage 410 is depicted in FIG. 4 for simplicity, but various aspects stored in storage 410 may be stored in different physical storages, but all accessible to CPU 402 via internal data connections, such as bus 416, or external connection, such as network interfaces 406. One of skill in the art will appreciate that one or more elements of server 400 may be located remotely and accessed via a network 414.

### EXAMPLE CLAUSES

Implementation examples are described in the following numbered clauses:

Clause 1: A method comprising receiving a plurality of transaction events, each transaction event comprising an entity attribute identifying an associated entity of a first type or a second type, a first account type, a second account type, and a transaction type; grouping the plurality of transaction events based on the entity attribute to a first entity group and second entity group; grouping the plurality of transaction events in transaction groups within the first entity group and second entity group, based on transaction type; generating a first probability value for the first entity group and second probability value for the second entity group, each of the first and second probability value comprising a probability value of the first account type given the second account type; identifying that the first probability value is greater than the second probability value for transaction events grouped together based on transaction type; and providing an indication to an application associated with an entity of the second entity type, to modify one of the first account type and the second account type of a subsequent transaction event.

Clause 2: The method of Clause 1, wherein the identifying comprises determining that the first probability value is overexpressed relative to the second probability value.

Clause 3: The method of any one of Clause 1 or Clause 2, further comprising: receiving the plurality of transaction events are received from a plurality of applications, wherein the first entity type or second entity type are associated with each of the plurality of transaction events responsive to the presence of financial services transactions received from each of the plurality of applications.

Clause 4: The method of any one of Clauses 1-3, wherein each of the plurality of transaction events further comprises a transaction context comprising at least one of an identifier, an industry identifier, a size, or a business type, of a first party or a second party to each of the plurality of transaction events, a transaction date, and a transaction amount.

Clause 5: The method of any one of Clauses 1-4, further comprising generating a vector from the transaction context.

Clause 6: The method of any one of Clauses 1-5, wherein receiving the plurality of transaction events further comprises receiving a third account and a fourth account for each of the plurality of transaction events; and grouping the plurality of transaction events in transaction groups within the first entity group and second entity group is based on a first account type, a second account type, the third account type, and the fourth account type.

Clause 7: The method of Clause 1-6, wherein the generating for each transaction group, a probability value, comprises generating the probability value of the first account type and third account type given the second account type and fourth account type.

Clause 8: A processing system, comprising means for performing a method in accordance with any one of Clauses 1-7.

Clause 9: A non-transitory computer-readable medium comprising computer-executable instructions that, when executed by one or more processors of a processing system, cause the processing system to perform a method in accordance with any one of Clauses 1-7.

Clause 10: A computer program product embodied on a computer-readable storage medium comprising code for performing a method in accordance with any one of Clauses 1-7.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method comprising:
receiving a plurality of transaction events, each transaction event comprising an entity attribute identifying an associated entity of a first type or a second type, a first account type, a second account type, and a transaction type;
grouping the plurality of transaction events based on the entity attribute to a first entity group and second entity group;
generating a first probability value for the first entity group and a second probability value for the second entity group, each of the first and second probability value comprising a probability value of the first account type given the second account type;
identifying that the first probability value is greater than the second probability value for transaction events grouped together based on transaction type; and
providing a recommendation to an application associated with an entity of the second entity type, to modify one of the first account type and the second account type of a subsequent transaction event.

2. The method of claim 1, wherein the identifying comprises determining that the first probability value is overexpressed relative to the second probability value.

3. The method of claim 2, further comprising:
receiving the plurality of transaction events are received from a plurality of applications,
wherein the first entity type or second entity type are associated with each of the plurality of transaction events responsive to financial services transactions received from each of the plurality of applications.

4. The method of claim 2, wherein each of the plurality of transaction events further comprises a transaction attribute comprising at least one of an identifier, an industry identifier, a size, or a business type, of a first party or a second party to each of the plurality of transaction events, a transaction date, and a transaction amount.

5. The method of claim 4, further comprising generating a vector from the transaction attribute.

6. The method of claim 1, wherein:
receiving the plurality of transaction events further comprises receiving a third account and a fourth account for each of the plurality of transaction events; and
grouping the plurality of transaction events in transaction groups within the first entity group and second entity group is based on a first account type, a second account type, the third account type, and the fourth account type.

7. The method of claim 6, wherein the generating for each transaction group, a probability value, comprises generating the probability value of the first account type and third account type given the second account type and fourth account type.

8. A system comprising:
a memory comprising computer-readable instructions;
a processor configured to execute the computer-readable instructions that cause the system to:
receive a plurality of transaction events, each transaction event comprising an entity attribute identifying an associated entity of a first type or a second type, a first account type, a second account type, and a transaction type;
group the plurality of transaction events based on the entity attribute to a first entity group and second entity group;
generate a first probability value for the first entity group and a second probability value for the second entity group, each of the first and second probability value comprising a probability value of the first account type given the second account type;
identify that the first probability value is greater than the second probability value for transaction events grouped together based on transaction type; and
provide recommendation to an application associated with an entity of the second entity type, to modify one of the first account type and the second account type of a subsequent transaction event.

9. The system of claim 8, wherein the instruction that causes the processor to identify further causes the processor to determine that the first probability value is overexpressed relative to the second probability value.

10. The system of claim 9, the computer-readable instructions further causing the processor to:
receiving the plurality of transaction events are received from a plurality of applications,
wherein the first entity type or second entity type are associated with each of the plurality of transaction events responsive to financial services transactions received from each of the plurality of applications.

11. The system of claim 9, wherein each of the plurality of transaction events further comprises a transaction attribute comprising at least one of an identifier, an industry identifier, a size, or a business type, of a first party or a second party to each of the plurality of transaction events, a transaction date, and a transaction amount.

12. The system of claim 11, the computer-readable instruction further causing the processor to generate a vector from the transaction attribute.

13. The system of claim 8, wherein the computer-readable instructions that cause the processor to:
receive the plurality of transaction events further comprises receiving a third account and a fourth account for each of the plurality of transaction events; and
group the plurality of transaction events in transaction groups within the first entity group and second entity group is based on a first account type, a second account type, the third account type, and the fourth account type.

14. The system of claim 13, wherein the computer-readable instructions that cause the processor to generate a probability value for each transaction group, comprises instructions to cause the processor to generate the probability value of the first account type and third account type given the second account type and fourth account type.

15. A system for recommending an account for recordation of a transaction, comprising:
a memory comprising computer-readable instructions;
a processor configured to execute the computer-readable instructions, that cause the system to:
receive a plurality of transactions, each comprising one or more journal entries;
group the plurality of transactions into one of an experienced group or an inexperienced group;
extract the one or more journal entries for each transaction, each journal entry comprising at least two accounts of a chart of accounts, and at least two journal entries being associated with each transaction of the plurality of transactions;
calculate, for each transaction, a probability value for a journal entry based on the at least two accounts;
identify an overexpressed probability value associated with transactions from the experienced group relative to the inexperienced group;
generate a recommendation for the inexperienced group based on the overexpressed probability value; and
transmit the recommendation to the inexperienced group.

16. The system of claim 15, the computer-readable instructions further causing the system to:
receive a transaction size attribute for each transaction;
wherein the computer-readable instruction to generate further comprises generate the recommendation based on the transaction size attribute.

17. The system of claim 15, the computer-readable instructions further comprising instructions that cause the system to match each party to each transaction of the plurality of transactions against a third party application.

18. The system of claim 15, the computer-readable instructions further comprising instructions that cause the system to compare a chart of accounts of the experienced group to a chart of accounts of the inexperienced group;

19. The system of claim 18, the computer-readable instructions further comprising instructions that cause the system to identify a first account of the chart of accounts of the experienced group that is not present in the chart of accounts for the inexperienced group.

20. The system of claim 19, the computer-readable instructions further comprising instructions that cause the system to generate a second recommendation for the inexperienced group based on the first account.
